(19) United States
(12) Patent Application Publication
(10) Pub. No.: US 2016/0322052 A1
(43) Pub. Date: Nov. 3, 2016

(54) Method and System for Generating a Control Command

(71) Applicant: Bayerische Motoren Werke Aktiengesellschaft, Muenchen (DE)

(72) Inventors: Wolfgang HABERL, Muenchen (DE); Karsten KNEBEL, Muenchen (DE)

(21) Appl. No.: 15/209,819

(22) Filed: Jul. 14, 2016

Related U.S. Application Data
(63) Continuation of application No. PCT/EP2014/078730, filed on Dec. 19, 2014.

(30) Foreign Application Priority Data
Jan. 15, 2014 (DE) 10 2014 200 570.1

(51) Int. Cl. G10L 15/32; G10L 15/30; G10L 15/22

(52) U.S. Cl. CPC G10L 15/32; G10L 15/22; G10L 15/30; G10L 2015/223

(57) ABSTRACT

A method is provided for generating a control command from a verbal statement that contains unrestricted phrasing and user-specific terms. The method includes the acts of: a) recording a voice command that has a multiplicity of words as an audio data stream by a recording device; b) sending of the audio data stream via a network to a first voice recognition device; c) reception of at least one data packet from the first voice recognition device, wherein the data packet contains information concerning which words in the audio data stream have not been recognized; d) at least partial recomition of the words that have not been recognized by the first voice recognition device by a second voice recognition device using at least one database; e compilation of the results from the first and second voice recognition devices to form a control command; and f) output of the control command.

### CROSS REFERENCE TO RELATED APPLICATIONS

This application is a continuation of PCT International Application No. PCT/EP2014/078730, filed Dec. 19, 2014, which claims priority under 35 U.S.C. §119 from German Patent Application No. 10 2014 200 570.1, filed Jan. 15, 2014, the entire disclosures of which are herein expressly incorporated by reference.

### BACKGROUND AND SUMMARY OF THE INVENTION

The invention relates to a method for generating a control command from a verbal statement and a system for performing a corresponding process.

Voice recognition systems voice dialogue systems simplify the operation of certain devices in that they facilitate a voice control of certain functions. This is of particular use in situations as with driving a vehicle, where a manual operation of the devices is not desired or permitted. For example, in a vehicle, a multi-media system, a navigation system or a hands-fee system or mobile phone can be operated by voice control.

For this purpose, there are embedded voice recognition systems or device-integrated voice dialogue systems, which can recognize and process a series of commands. These systems are available locally on the user's device (vehicle, mobile phone, or the like). However, because of a limited processing power of the local processing unit, unrestricted phrase voice commands often are not understood or require much processing time. The user often has to adapt to the command structure of the voice recognition system or adhere to a specified command syntax. Depending on the situation, there is also a high error rate.

To be able to state unrestricted voice commands, server-based voice recognition systems are used. To that end, the inputted phrase is sent to a voice recognition server, where it is processed with recognition software. In doing so, a higher available processing power and a larger volume of stored vocabulary facilitate greater accuracy. In this way, even colloquial or everyday phrases can be recognized and understood.

However, there are parts of statements that cannot be processed by a server-based voice recognition, or can be processed only poorly by server-based voice recognition. Parts of a statement that are not recognized, or only poorly recognized, may be in particular individual words that originate from a user-specific vocabulary. Examples of user-specific vocabulary are contacts in an address or phone book or titles in a music collection.

A solution for this problem is to allow the voice recognition server access to a database with the user data to be recognized (address book, music collection). The data can be available locally on a user's device (such as the onboard computer of a vehicle or a mobile phone, for example). The data can be loaded on the server and in this way made accessible to the server-based voice recognition system. This, however, presents a potential data protection problem if it is a user's private data. An encryption mechanism would be required for the transmission and storage of the data on the server to prevent third parties from accessing it. Furthermore, an increased data transmission volume is required to load large databases on the server and update them on a regular basis. This can be cost-intensive, in particular for systems attached via mobile phone.

Therefore, there is an interest in facilitating a voice-controlled operation of devices and/or device functions for the user, in particular, a voice recognition of unrestricted phrasing is desired. Additionally, there are a number of user-specific terms, such as address book entries, which are also to be recognizable for a user-friendly voice control,

Proceeding from these requirements, the object to be attained by the present invention is to provide a method that reliably and efficiently generates control commands from verbal statements. Furthermore, the invention is to provide a system that is developed to perform an appropriate process.

This and other objects are achieved with a method comprising the following acts:

a) Recording a voice command that comprises a multiplicity of words, as an audio data stream by a recording device;

b) Sending the audio data stream via a network to a first voice recognition device;

c) Receiving, in particular via the network, at least one data packet from the first voice recognition device, with the data packet containing information as to which words in the audio data stream were not recognized;

d) At least partial recognition of the words not recognized by the first voice recognition device by a second voice recognition device using at least one database;

e) Compiling the results of the first and second voice recognition device into a control command; and

f) Outputting the Control Command.

According to the invention, the task of recognizing and processing a verbal statement is assigned to two voice recognition devices. In this way, the advantages of the respective voice recognition devices can be utilized and the transmission of large amounts of data can be rendered obsolete.

Preferably, the first voice recognition device is a server-based voice recognition, which because of a higher processing power and an extensive vocabulary, is able to recognize even unrestricted phrases and interpret them. However, the first voice recognition device perhaps cannot, or can only poorly, recognize individual user-specific words, such as, for example, address book entries or music titles.

However, these words may be present in one or a plurality of databases on one or a plurality of storage media. These can in particular be storage media in the user's mobile devices (such as vehicle, mobile phone).

A second voice recognition device at least partially recognizes the words not recognized by the first voice recognition as far as they are words from one of the local databases. Generally, the second voice recognition device will be constructed such that it cannot recognize unrestricted phrases, but rather supplements a voice command largely recognized by the first voice recognition device with individual terms from the local databases and combines them therewith.

Preferably, there is an existing processing unit with the second voice recognition device, which is connected to the local databases. Because the hardware needed to perform the method (such as microphone, sending/receiving unit, processing uni already available in many devices, it can be advantageous to connect existing devices (vehicle, mobile phone or the like) and use them for the described method. The connection can be executed in particular via a short-range wireless communication (“short range devices”) or wire-connected.

To generate a control command from the recognized voice command, for example for a vehicle, the first voice recognition device can comprise a set of vehicle-specific commands. A control command is then generated from the recognized voice command; said control command is sent to a processing unit with the second voice recognition device and, if needed, supplemented by the second voice recognition device with single terms, and finally outputted.

An idea of the present invention is that the data to be recognized are present at the corresponding voice recognition device. For example, the general components of a statement are recognized by a voice recognition device on a server on which a general, comprehensive dictionary in the appropriate language is available. Accordingly, the voice recognition software can be non-specific to the user because it relates to general vocabulary. Updates are then also easier to perform because they have the same effect on all users.

User-specific data, on the other hand, are recognized by the second voice recognition device, on the user's device on which the appropriate databases are available (address book, music collection) or to which they are connected locally.

Compared to uploading the databases to the server, this has the decisive advantage that there are no potential problems with respect to data protection or data safety because the data remains locally on the device and the server has no access to it. Furthermore, potential tile phone costs, which would be incurred by transmitting the databases and continually updating them, are avoided.

The first voice recognition device can compile one or a plurality of data packets that include the result of the voice recognition as well uknown identification of the words that were not recognized or only poorly recognized in the original voice command. A potential identification can be that the first voice recognition device transmits time and/or position information about the appropriate words within the audio data stream.

The data packets can be received and processed by a processing unit. Words that are identified as not having been recognized can be transmitted to the second voice recognition device for recognition.

After a control command composed of parts recognized by the first and by the second voice recognition device is outputted, the control command can be transmitted to a receiver. The receiver is generally a navigation device, a multi-media system and/or a hands-free system in a vehicle. The communication between the voice command receiver and the processing unit then takes place in particular via a vehicle bus. In doing so, voice commands can be used to control the function of devices such as, for example, dialing a phone number, starting a navigation, playing a musical title, opening/closing the sliding roof, adjusting a seat, opening the trunk). This simplifies the operation and makes space for switches or the like obsolete. During driving, a verbal operation furthermore creates less distraction for the driver than a manual operation.

In one embodiment, the audio data stream recorded by the recording device can be sent via a public network. In particular, this can be a mobile communications network. This is relevant in particular if the apparatuses for performing the steps a) to f) of the method according to the invention are mobile, for example if they are components of a vehicle. The connection to the server must then be executed wirelessly, for example via mobile communication.

The apparatuses provided for performing the steps a) to f) of the method according to the invention should also be connected. This can be wired connections (such as a vehicle bus) or short-range wireless connections (“short range devices”, such as Bluetooth, for example).

The aforementioned object can be attained furthermore by a system that comprises at least one recording device to record a voice command and at least one storage medium with at least one database, as well as a device for receiving at least one data packet from a first voice recognition device, with the data packet containing an identification of words that were not recognized in the voice command, and a second voice recognition device to recognize the identified words using the at least one database. The second voice recognition device can be integrated in the device for receiving the data packet.

The system can be designed to perform one of the methods described above. Likewise, the described methods can use all or some of the components of the system described above or in the following to implement the individual steps.

In another embodiment, the system further includes a processing unit with the second voice recognition device, wherein a wired connection and/or a short-range wireless connection, in particular via Bluetooth, exists between the processing unit, the recording device and the storage medium. In particular, the various apparatuses of the system can be located in one single device. The device can be in particular a vehicle or a mobile phone or a component of a vehicle or mobile phone. Distributing the apparatuses to a plurality of connected devices is also contemplated.

In addition to the aforementioned apparatuses, the system can also include a server on which the first voice recognition device is located. A wireless connection via a public network ought to exist between the server and the processing unit with the second voice recognition device. This can be in particular a mobile communications network. The server is in particular largely stationary, whereas the other components of the system can be designed to be mobile. The server can offer a web service and therefore be accessible via the Internet.

In another embodiment, the system further includes a vehicle, with one or a plurality of apparatuses for performing the method—with the exception of the server—being vehicle components. For example, the processing unit, the storage medium and/or the recording device can be available in the vehicle. It is possible, for example, that the onboard computer system of the vehicle constitutes the processing unit, one of the databases is on an internal storage of the vehicle, and the recording device is the microphone of a mobile phone. The phone can be connected to the vehicle via Bluetooth. One advantage of this is that the required hardware (storage medium, recording device, processing unit) is already available and interconnected or a connection can be easily established.

The processing unit can be designed to transmit the control command generated from the recognized voice command to at least one device for controlling device functions. The transmission can take place via a vehicle bus. The receiving devices can be in particular a navigation system, a multi-media system and/or a hands-free system in a vehicle.

The aforementioned object is furthermore attained by a computer-readable medium with instructions, which, if executed on a processing unit, perform one of the methods described above,

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a flow chart of the method;

FIG. 2 is a schematic representation of the system;

FIG. 3 is a schematic system with a vehicle and a mobile phone;

FIG. 4 illustrates a voice command that comprises a multitude of words;

FIG. 5 illustrates control commands and information generated from a voice command;

FIG. 6 illustrates a recognition of words that were not recognized by a second voice recognition device; and

FIG. 7 illustrates a compilation of parts of a control command into a control command.

### DETAILED DESCRIPTION OF THE DRAWINGS

In the description below, the same reference numbers are used for parts that are identical or have an identical function or effect.

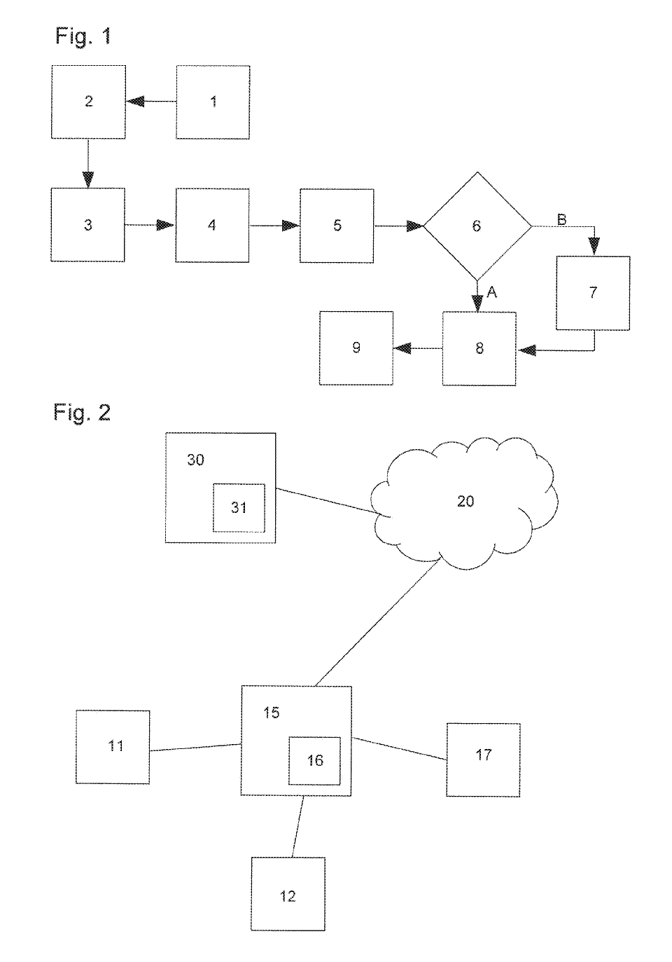

FIG. 1 shows a possible process flow of the method. In the beginning, a voice command is recorded as audio data stream I. The audio data stream is sent to a first voice recognition device 2. The first voice recognition device checks and recognizes 3 the content of the audio data stream and identifies 4 recognized and unrecognized parts of the recording. The result obtained in this manner is received 5 and processed in such a way that a breakdown 6 into parts with successful A and unsuccessful B voice recognition is performed. Unrecognized parts B are at least partially recognized 7 by a second voice recognition device. The information obtained in this manner is compiled 8 with the recognized parts A from the first voice recognition device into a control command. Finally, the control command is transmitted to a receiver 9.

FIG. 2 shows the structure of a corresponding system, which is designed to perform the aforementioned method. A processing unit 15 is connected to a recording device 11, a storage medium 17 and a control command receiver. Via a network 20, the processing unit 15 is furthermore connected to a server 30. On the server 30 is a first voice recognition device 31, and on the processing unit 15 is a second voice recognition device 16.

The connection between the processing unit 15, the recording device 11, the storage medium 17 and the control command receiver 12 is established via a short-range communication such as a vehicle bus, Bluetooth). The connection between the processing unit 15 and the server 30 takes place via a network, in particular a wireless network such as, for example, a mobile communications network.

This principally makes it feasible to install the processing unit 15, the recording device 11, the storage medium 17 and the control command receiver 12 in one device. However, there can also be a plurality of interconnected devices. Because the components 11, 15 and 17 exist in many modern devices (such as mobile phones, vehicles, notebooks), it is especially advantageous to connect such devices and use them to perform the method. In any case, the server 30 is not in a device with any of the other apparatuses.

The first voice recognition device 31 on the server 30 is preferably designed to capture an extensive vocabulary and understand unrestricted phrases. An important characteristic is furthermore that the voice recognition device can perform an identification 4 of the parts of the audio data stream that were not recognized or only poorly recognized.

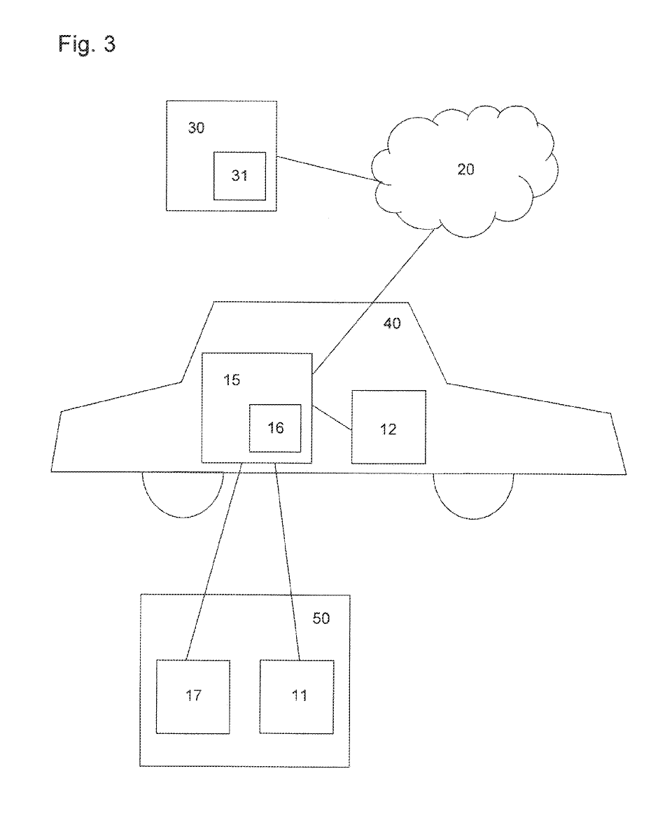

An exemplary embodiment of the system in FIG. 2 is shown in FIG. 3. Here, a vehicle 40 and a mobile phone 50 are shown in addition to the apparatuses already mentioned above. In the arrangement shown, the processing unit 15 is a component of the vehicle 40. Therefore, d can be implemented by the onboard computer system, for example. The receiver 12 of the control command is also in the vehicle 40. This scan therefore be the multimedia or infotainment system of the vehicle 40. The storage medium 17 with the data of a user is a memory card in the mobile phone 50. The data stored on the memory card may be contact data from the address or phone book, or titles of a collection of music, for example. In the example shown, the recording device 11 for the voice command is the microphone of the mobile phone.

Telephone 50 is connected to the vehicle 40 via Bluetooth or another The short-range communication. The connection can also be executed via wire.

In particular, in the exemplary embodiment show in FIG. 3, the processing unit 15, the recording device 11, the storage medium 17, and the control command receiver 12 are mobile. The server 30 is generally stationary and the connection to the processing unit 15 is established via a wireless network 20.

In addition to the embodiment shown in FIG. 3, other embodiments are possible, wherein the processing unit 15 is executed by another processor installed in the vehicle 40, or by the processor of the mobile phone 50.

In addition to the microphone of the mobile phone 50, the recording device 11 can be a microphone that is part of the vehicle 40, such as the hands-free system or designated microphone for voice control, for example. /

In addition to the storage card of the mobile phone 50, the storage medium 17 can also be the internal phone memory. Furthermore, the storage medium 17 can also be an internal memory in the vehicle 40 or a USB stick connected to the vehicle 40, a hard drive, or the like.

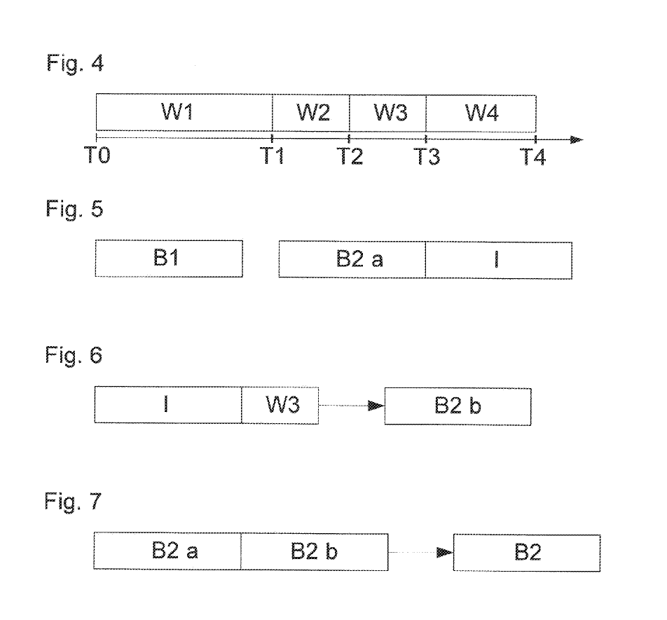

An example for generating a control command B according to the method according to the invention with the system shown in FIG. 3 is shown in the FIGS. 4 to 7. A voice command is spoken into the microphone 11 of the mobile telephone 50. For example, this may be the sentence: “Close the windows and call Tobias Birm.” The onboard computer system 15 of the vehicle 40 sends the recording of the voice command via a mobile communications network 20 to the server 30, where it is processed in terms of voice recognition. The phrase “Close the window” corresponds to W1; the phrase “and call [toll]” corresponds to W2; the phrase “Tobias Birm” corresponds to W3; and the phrase “to” corresponds to W4 in FIG. 4. The voice recognition software 31 recognizes W1. W2 and W4, but not W3. As shown in FIG. 5, the voice recognition device 31 generates the control command 31 for closing the window from W1. From the recognized words W2 and W4, the voice recognition device 31 generates the control command B2a, to execute a call, in conjunction with the information 1 that said command relates to the part of the voice command between the time markers T2 and T3. The information I is received by the onboard computer system 15. As shown in FIG. 6, a voice recognition program 16 installed on the onboard computer system 15 also compares the section W3, which was identified by the time markers T2 and T3, to words from the user's address book. In FIG. 7, the recognized name “Tobias Bim” B2b is combined by the onboard computer system 15 with the control command B2A into a control command B2, which initiates a call to Tobias Birn.

Besides the statements W and control commands B mentioned in FIGS. 4 to 7 and the related description, random statements W and control commands B can be used. Furthermore, the control command B can also be generated by the processing unit 15.

The identification of the unrecognized words W can be achieved by time markers T as well as by other characterizing measures.

The recognition of the voice command B can also first take place by the second voice recognition device 16 and then be sent to the first voice recognition device 31 for recognition of general statements.

According to the invention, the embodiments described in detail can be combined in various ways.

### LIST OF REFERENCE SYMBOLS

1 Recording a voice command

2 Sending the recording to a first voice recognition system

3 Recognition by a first voice recognition system

4 Identification of unrecognized parts of the recording

5 Receiving the result

6 Breaking down the recording to parts with
A: successful voice recognition
B: unsuccessful voice recognition

7 Voice recognition by a second voice recognition system

8 Combining the voice recognition results

9 Transmitting the control command to a receiver

11 Voice command receiving device

12 Control command receiver

15 Processing unit

16 Second voice recognition system

17 Storage medium

20 Network

30 Server

31 First voice recognition system

40 Vehicle

50 Mobile phone

W1-W4 Sections of one or a plurality of words in a voice command

T0-T4 Time markers in an audio data stream

B1/2 Control commands
1 Information about unrecognized words

The foregoing disclosure has been set forth nerely to illustrate the invention and is not intended to he limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for generating a control command, the method comprising the acts of:
a) recording a voice command as an audio data stream by a recording device, the voice command comprising a multiplicity of words;
b) sending the audio data stream via a network to a first voice recognition device;
c) receiving, via the network, at least one data packet from the first voice recognition device, wherein the data packet contains information concerning words in the audio data stream that were not recognized;
d) at least partially recognizing, via a second voice recognition device using at least one database, the words in the audio data stream that were not recognized by the first voice recognition device;
e) compiling results of the first voice recognition device and the second voice recognition device into a control command; and
f) outputting the control command,

2. The method according to claim 1, further comprising the act of:
g) identifying the unrecognized words in the audio data stream by the first voice recognition device and preparing the data packet by the first voice recognition device.

3. The method according to claim 2, wherein the act g) comprises:
identifying the unrecognized words in the audio data stream by time and/or position information within the audio data stream.

4. The method according to claim 2, further comprising the act of:
h) processing the at least one data packet by a processing unit and sending the words marked as unrecognized to the second voice recognition device.

5. The method according to claim 1, wherein the act 0 comprises:
transmitting the control command, via a vehicle bus, to at least one receiver in order to control functions.

6. The method according to claim 1, wherein the act b) comprises:
sending the audio data stream via a public network.

7. The method according to claim 6, wherein the public network is a mobile communications network.

8. The method according to claim 4, wherein devices provided to carry out acts a) to f) and h) are interconnected by wire and/or short-range wireless communication,

9. The method according to claim 8, wherein the short-range wireless communication is Bluetooth.

10. A system for generating a control command, the system comprising:
a recording device for recording a voice command that comprises a multiplicity of words;
a storage medium having at least one database;
a device that receives at least one data packet from a first voice recognition device, wherein the data packet contains an identification of unrecognized words in the voice command and
a second voice recognition device that analyzes and recognizes the identified unrecognized words using the at least one database.

11. The system according to claim 10, further comprising:
a processing unit of the second voice recognition device, wherein a wired and/or a short-range wireless connection is provided between the processing unit, the recording device and the storage medium.

12. The system according to claim 11, further comprising:
a server having the first voice recognition device, wherein a wireless connection is provided via a public network between the processing unit and the server.

13. The system according to claim 12, further comprising a vehicle, wherein the processing unit, the storage medium and/or the recording device are component of the vehicle.

14. The system according to claim 13, wherein the processing unit is configured to transmit a control command via a vehicle bus to a receiver in order to control functions of the vehicle.

15. A computer product comprising a non-transitory computer readable medium having stored thereon program code that, when executed by a processor, causes:
a) recording a voice command as an audio data stream by a recording device, the voice command comprising a multiplicity of words;
b) sending the audio data stream via a network to a first voice recognition device;
c) receiving, via the network, at least one data packet from the first voice recognition device, wherein the data packet contains information concerning words in the audio data stream that were not recognized;
d) at least partially recognizing, via a second voice recognition device using at least one database, the words in the audio data stream that were not recognized by the first voice recognition device;
e) compiling results of the first voice recognition device and the second voice recognition device into a control command; and
f) outputting the control command.
